(19) United States
(12) Patent Application Publication
(10) Pub. No.: US 2017/0300190 A1
(43) Pub. Date: Oct. 19, 2017

(54) METHOD AND DEVICE FOR PROCESSING OPERATION

(71) Applicant: Beijing Xiaomi Mobile Software Co., Ltd., Beijing (CN)

(72) Inventors: Shuo WANG, Beijing (CN); Dongya JIANG, Beijing (CN); Guangjian WANG, Beijing (CN)

(73) Assignee: Beijing Xiaomi Mobile Software Co., Ltd.

(21) Appl. No.: 15/417,506

(22) Filed: Jan. 27, 2017

(30) Foreign Application Priority Data
Apr. 13, 2016 (CN) 201610228004.4

(51) Int. Cl. G06F 3/0482; G06F 3/0484; G06F 3/0488

(52) U.S. Cl. CPC G06F 3/0482; G06F 3/0488; G06F 3/04842; G06F 3/04845

(57) ABSTRACT

A method for processing an operation includes displaying a graphical representation on a terminal interface. The graphical representation includes a slidable region and a response region. The response region includes a plurality of response segments, each of which corresponds to one function. The method further includes acquiring, when a sliding operation on the slidable region is detected, a position of an end point of the sliding operation in the response region, determining a target function according to the position of the end point, and enabling the target function. The target function corresponds to a response segment in which the position of the end point is located.

### CROSS-REFERENCE TO RELATED APPLICATIONS

The present application is based upon and claims priority to Chinese Patent Application No. 201610228004.4, filed Apr. 13, 2016, the entire contents of which are incorporated herein by reference.

### TECHNICAL FIELD

The present disclosure generally relates to terminals and, more particularly, to a method and device for operation processing.

### BACKGROUND

With the development of terminal technologies, terminals having a touch screen are used more and more widely. Operations of the terminals have become simpler and more manners for inputting instructions on the terminals have been developed. A terminal can perform a corresponding operation when detecting a user's operation, such as a single-touch, a multi-touch, or a sliding operation.

For example, in conventional technologies, when the user wishes to change a desktop wallpaper, the terminal displays a system setting interface after detecting a trigger operation by the user on a system setting option. Then, when the terminal detects a trigger operation on a wallpaper setting option on the system setting interface, the terminal displays a wallpaper setting interface, which at least includes a plurality of wallpapers. When the terminal detects a selection operation on any wallpaper, the terminal sets the selected wallpaper as the desktop wallpaper.

### SUMMARY

In accordance with the present disclosure, there is provided a method for processing an operation including displaying a graphical representation on a terminal interface. The graphical representation includes a slidable region and a response region. The response region includes a plurality of response segments, each of which corresponds to one function. The method further includes acquiring, when a sliding operation on the slidable region is detected, a position of an end point of the sliding operation in the response region, determining a target function according to the position of the end point, and enabling the target function. The target function corresponds to a response segment in which the position of the end point is located.

Also in accordance with the present disclosure, there is provided a method for processing an operation including displaying a graphical representation on a terminal interface. The graphical representation includes a slidable region and a response region. The response region includes a plurality of response segments, each of which corresponds to one function. The method further includes acquiring, when a sliding operation on the slidable region is detected, a position of an end point of the sliding operation in the response region, acquiring a sliding duration during which the slidable region slides to the response region, and determining whether the sliding duration is shorter than a preset duration. If the sliding duration is shorter than the preset duration, the method also includes determining a target function according to the position of the end point and enabling the target function. The target function corresponds to a response segment in which the position of the end point is located.

Also in accordance with the present disclosure, there is provided a device for processing an operation including a processor and a memory storing instructions that, when executed by the processor, cause the processor to display a graphical representation on a terminal interface. The graphical representation includes a slidable region and a response region. The response region includes a plurality of response segments, each of which corresponds to one function. The instructions further cause the processor to acquire, when a sliding operation on the slidable region is detected, a position of an end point of the sliding operation in the response region, determine a target function according to the position of the end point, and enable the target function. The target function corresponds to a response segment in which the position of the end point is located.

Also in accordance with the present disclosure, there is provided a device for processing an operation including a processor and a memory storing instructions that, when executed by the processor, cause the processor to display a graphical representation on a terminal interface. The graphical representation includes a slidable region and a response region. The response region includes a plurality of response segments, each of which corresponds to one function. The instructions further cause the processor to acquire, when a sliding operation on the slidable region is detected, a position of an end point of the sliding operation in the response region, acquire a sliding duration during which the slidable region slides to the response region, and determine whether the sliding duration is shorter than a preset duration. If the sliding duration is shorter than the preset duration, the instructions also cause the processor to determine a target function according to the position of the end point and enable the target function. The target function corresponds to a response segment in which the position of the end point is located.

Also in accordance with the present disclosure, there is provided a non-transitory computer-readable storage medium storing instructions that, when executed by a processor in a terminal, cause the terminal to display a graphical representation on a terminal interface. The graphical representation includes a slidable region and a response region. The response region includes a plurality of response segments, each of which corresponds to one function. The instructions further cause the terminal to acquire, when a sliding operation on the slidable region is detected, a position of an end point of the sliding operation in the response region, determine a target function according to the position of the end point, and enable the target function. The target function corresponds to a response segment in which the position of the end point is located.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for processing an operation according to an exemplary embodiment.

FIG. 2A is a flow chart of a method for processing an operation according to another exemplary embodiment.

FIG. 2B is a schematic diagram showing graphical representations according to exemplary embodiments.

FIG. 2C is a schematic diagram showing a terminal interface according to an exemplary embodiment.

FIG. 3 is a block diagram of a device for processing an operation according to an exemplary embodiment.

FIG. 4 is a block diagram of a device for processing an operation according to another exemplary embodiment.

### DETAILED DESCRIPTION

The objects, technical solutions, and advantages of the present disclosure will be more apparent from the following detailed description of implementations of the present disclosure taken in conjunction with the accompanying drawings.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the invention as recited in the appended claims. A method consistent with the present disclosure can be implemented, for example, in a terminal.

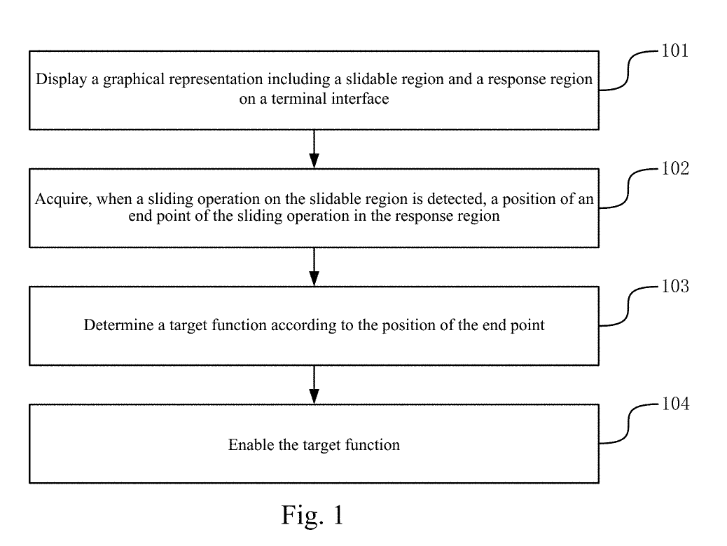

FIG. 1 is a flow chart of a method for processing an operation according to an exemplary embodiment. As shown in FIG. 1, at 101, a graphical (floating) representation including a slidable region and a response region is displayed on a terminal interface. The response region includes a plurality of response segments, and each response segment corresponds to one function. The function can be, for example, a function that can be performed by the terminal. At 102, when a sliding operation on the slidable region is detected, a position of an end point of the sliding operation in the response region is acquired. At 103, a target function is determined according to the position of the end point. The target function is a function corresponding to a response segment in which the position of the end point is located. At 104, the target function is enabled.

In some embodiments, before the target function is determined according to the position of the end point, a sliding duration is acquired when the sliding operation on the slidable region is detected. The sliding duration refers to a time period within which the user slides the slidable region to the response region. It is determined whether the sliding duration is shorter than a preset duration. If the sliding duration is shorter than the preset duration, the target function is determined according to the position of the end point. On the other hand, if the sliding duration is longer than or equals the preset duration, no action is taken to respond to the sliding operation.

According to the present disclosure, the target function depends on the position of the end point. For example, the target function is determined to be a screenshot function if the position of the end point is in a first response segment, or a lock screen function if the position of the end point is in a second response segment.

In some embodiments, a center of the slidable region overlaps a center of the response region.

In some embodiments, the slidable region has a circular shape, and the response region has an annular shape surrounding the slidable region.

In some embodiments, there is a preset distance between the slidable region and the response region.

Other embodiments consistent with the present disclosure can include one or more of the above described features, and are not discussed in detail here.

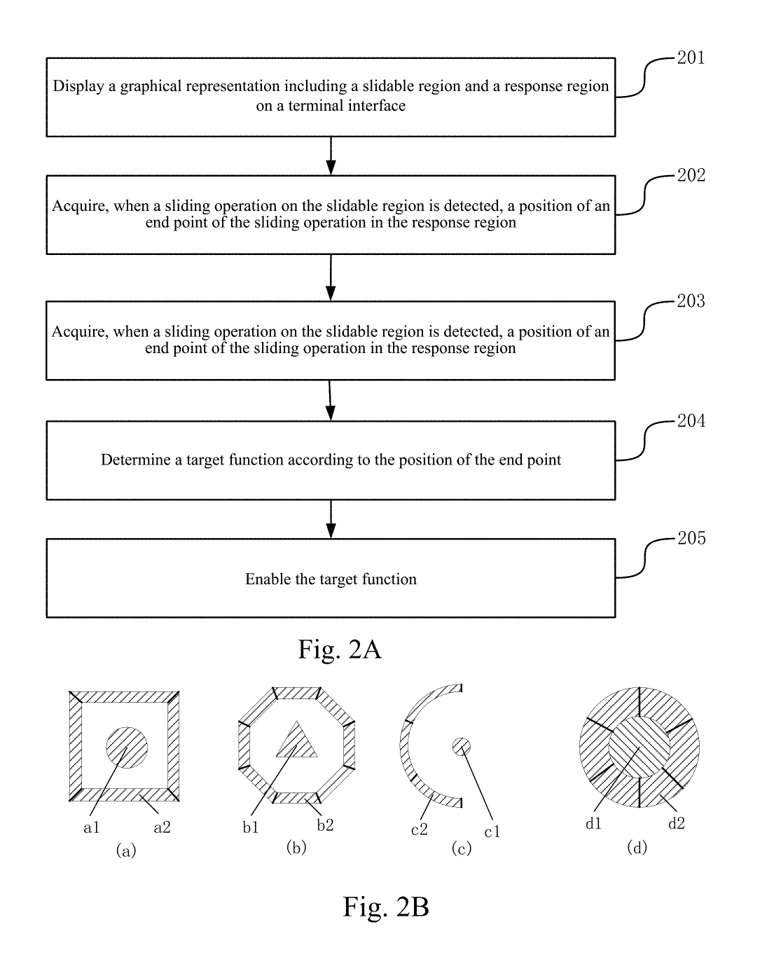

FIG. 2A is a flow chart of a method for processing an operation according to another exemplary embodiment. As shown in FIG. 2A, at 201, a graphical representation including a slidable region and a response region is displayed on a terminal interface. The response region includes a plurality of response segments, and each response segment corresponds to one function.

For example, when an unlock operation to unlock the terminal is detected, the terminal displays a system interface and also displays the graphical representation on the system interface. The graphical representation provides shortcuts to some functions that can be performed by the terminal so that the user can more easily access these functions. In some embodiments, the graphical representation can be fixed at any position on the terminal interface. Alternatively, the graphical representation can be moved to a corresponding position on the terminal interface according to a sliding operation on a sensing region of the graphical representation by the user.

The slidable region and the response region of the graphical representation can be of different shapes. FIG. 2B shows the shapes of four exemplary graphical representations consistent with the present disclosure. For example, the exemplary graphical representation shown in FIG. 2B(a) includes a slidable region a1 having a circular shape and a response region a2 having a square-frame shape; the exemplary graphical representation shown in FIG. 2B(b) includes a slidable region b1 having a triangular shape and a response region b2 having a regular-octagon-frame shape; the exemplary graphical representation shown in FIG. 2B(c) includes a slidable region c1 having a circular shape and a response region c2 having a semi-annular shape; and the exemplary graphical representation shown in FIG. 2B(d) includes a slidable region d1 having a circular shape and a response region d2 having an annular shape. Consistent with the present disclosure, the slidable region and the response region can also have other shapes.

The number of response segments included in the response region can be a system-default value, or can be set according to the user' needs. Further, division of the response region into the response segments and the correspondence between the response segments and the functions can also be system-default or be set by the user.

In some embodiments, the number of response segments can be the same for response segments of different shapes. In some embodiments, the number of response segments in the response region can be determined according to the shape of the response region, and can be different for response segments of different shapes, as shown in FIG. 2B, where neighboring response segments are shown separated from each other by a separator represented by a short thick line in the drawings. For example, in FIG. 2B(a), the response region a2 is divided into four frame sides by the separators, with each frame side between two adjacent separators being one response segment. In FIG. 2B(b), the response region b2 is divided into eight frame sides by the separators, with each frame side between two adjacent separators being one response segment. In FIG. 2B(c), the response region c2 is divided into three arcs by the separators, with each arc between two adjacent separators being one response segment. In FIG. 2B(d), the response region d2 is divided into six arcs by the separators, with each arc between two adjacent separators being one response segment. Areas of different response segments can be the same or different.

There can be a preset distance between a start position of the slidable region, i.e., the position of the slidable region before sliding, and the response region, such that the user can slide the slidable region to a particular position in the response region to trigger the terminal to perform a corresponding operation. The preset distance can be set to any fixed value, or be determined according to various approaches. For example, a plurality candidate values can be pre-stored in in the terminal system for the user to choose. In some embodiments, the preset distance can be set to zero, i.e., there is no interval between the slidable region and the response region. For example, as shown in FIG. 2B(d), the response region is arranged outside of the slidable region and touches the slidable region.

In some embodiments, a center of the slidable region coincides with a geometric center of the response region, such that a sliding distance of the slidable region is the same when the slidable region is slid to any position in the response region. This also improves the appearance of the graphical representation.

FIG. 2C shows an exemplary terminal interface containing a graphical representation according to another exemplary embodiment. In the exemplary graphical representation shown in FIG. 2C, the slidable region has a circular shape (the central circular shaded region) and the response region has an annular shape (the outer annular shaded region) surrounding the slidable region.

Referring again to FIG. 2A, at 202, when a sliding operation on the slidable region is detected, a position of an end point of the sliding operation in the response region is acquired. A sliding operation refers to an operation beginning with the user touching (or contacting) the terminal interface and ending with the user withdrawing touch (contact) from the terminal interface. In some embodiments, to acquire the position of the end point of the sliding operation in the response region, coordinates of the touch point when the user withdraws touch from the terminal interface are acquired as the position of the end point of the sliding operation in the response region.

At 203, when the sliding operation on the slidable region is detected, a sliding duration, i.e., a time period during which the user slides from the slidable region to the response region, is acquired. The sliding duration can be acquired using various approaches. For example, a start time when the user touches the terminal interface and an end time when the user withdraws touch from the terminal interface are acquired, and the sliding duration is acquired according to the start time and the end time.

After the sliding duration is acquired, whether the sliding duration is shorter than a preset duration is determined. If the sliding duration is shorter than the preset duration, the process proceeds further to 204 described below. On the other hand, if the sliding duration is greater than or equals the preset duration, the sliding operation is not responded to, and the process ends without proceeding to 204.

The preset duration can be set to any time period or can be set according to various approaches. In some embodiments, the preset duration can be determined according to an interval distance between the slidable region and the response region. For example, if the preset distance is 0.5 cm, then the preset duration is 500 ms. In some embodiments, when a plurality of optional preset distances are stored in the terminal, a preset duration is set for each preset distance.

In some embodiments, when the sliding operation on the slidable region is detected, a sliding speed of the sliding operation can also be determined. The sliding speed refers to a sliding speed corresponding to a process of sliding from the start position of the slidable region to the response region. The sliding speed can be, for example, an average speed during the sliding of the slidable region to the response region, or can be a maximum speed during the sliding of the slidable region to the response region.

To acquire the sliding speed, coordinates of a start point at which the user touches the terminal interface and coordinates of an end point at which the user withdraws touch from the terminal interface are acquired. Further, a start time when the user touches the terminal interface and an end time when the user withdraws touch from the terminal interface are acquired. The sliding speed of the sliding operation is determined according to the coordinates of the start point, the coordinates of the position of the end point, the start time, and the end time.

In some embodiments, after the sliding speed is acquired, whether the sliding speed is greater than a preset speed is determined. If the sliding speed is greater than the preset speed, the process proceeds to 204 described below. On the other hand, if the sliding speed is lower than or equals the preset speed, the sliding operation is not responded to, and the process ends without proceeding to 204.

As discussed above, in some embodiments, the sliding duration or the sliding speed of the sliding operation are acquired, and whether to perform the action in 204 is determined according to whether the sliding duration is shorter than the preset duration or whether the sliding speed is greater than the preset speed. Thus, the accuracy of the operation can be improved and misoperation can be avoided.

At 204, a target function is determined according to the position of the end point. The target function is a function corresponding to a response segment in which the position of the end point is located. For example, if the position of the end point is in a first response segment, the target function is determined to be a screenshot function. If the position of the end point is in a second response segment, the target function is determined to be a lock screen function. The first response segment can be any response segment, and the second response segment can be any one of other response segments except the first response segment. For example, in the example shown in FIG. 2C, the response region includes four response segments: response segment 1, response segment 2, response segment 3, and response segment 4. The first response segment can be response segment 1 and the second response segment can be response segment 2. If it is detected that the slidable region slides from the start position to any position in response segment 1 and finally remains in response segment 1, the target function is determined to be the screenshot function. Similarly, if it is detected that the slidable region slides from the start position to any position in response segment 2 and finally remains in response segment 2, the target function is determined to be the lock screen function.

According to the present disclosure, the position of the end point can also be in another response segment, such as response segment 3 or response segment 4 shown in FIG. 2C. The target function can also be another function, such as a recording function, a desktop wallpaper setting function, a music play function, or the like.

According to the present disclosure, functions corresponding to various response segments can be set by system-default, or can be set by the user. For example, when a trigger operation for setting options on the response segments is detected, options of the number of response segments to be set are displayed. When a selection operation for a number of response segments by the user is detected, the selected number of response segments is determined as the number of response segments after the response region is divided, and a preview of candidate response segments is presented to the user. When a selection operation for one of the candidate response segments in the preview by the user is detected, the selected candidate response segment is determined as a response segment to be set. When a trigger operation for a function bar is detected, a plurality of candidate functions are displayed. When a selection operation for one of the plurality of candidate functions by the user is detected, the selected function is determined as a function corresponding to the selected response segment. In some embodiments, an addition option can also be displayed in the function bar, so that the user can add functions to be set by the user by performing the trigger operation for the addition option.

In some embodiments, a set matching relationship between the response segments and the functions is stored in a specified storage space. As such, when a sliding operation on the slidable region is detected, the target function can be determined according to the position of the end point of the sliding operation and the corresponding relationship between the response segments and the functions stored in the specified storage space.

At 205, the target function is enabled. That is, after the target function is determined according to the position of the end point, a corresponding target function is enabled to complete corresponding operations. For example, if the target function is the screenshot function, a screen capture function is first enabled to capture a screen of the terminal, and then the captured image is stored in a photo album. As another example, if the target function is the lock screen function, the lock screen function is enabled to perform a lock screen process on the terminal.

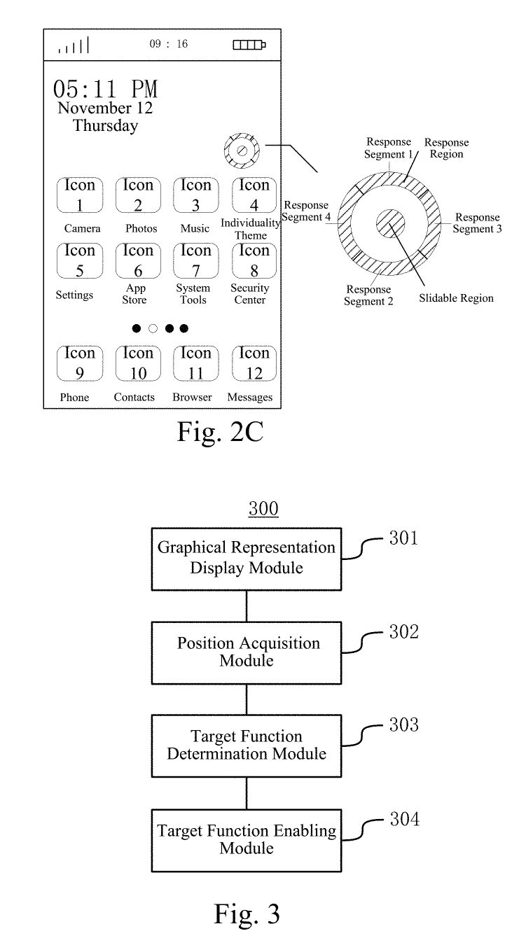

FIG. 3 is a block diagram of a device 300 for processing an operation according to an exemplary embodiment. Referring to FIG. 3, the device 300 includes a graphical representation display module 301, a position acquisition module 302, a target function determination module 303, and a target function enabling module 304. The graphical representation display module 301 is configured to display a graphical representation on a terminal interface. The graphical representation includes a slidable region and a response region. The response region includes a plurality of response segments, and each response segment corresponds to one function. The position acquisition module 302 is configured to, when a sliding operation on the slidable region is detected, acquire a position of an end point of the sliding operation in the response region. The target function determination module 303 is configured to determine a target function according to the position of the end point. The target function is a function corresponding to a response segment in which the position of the end point is located. The target function enable module 304 is configured to enable the target function.

In some embodiments, the device 300 further includes a sliding duration acquisition module, a determination module, and a processing module. The sliding duration acquisition module is configured to acquire a sliding duration, i.e., a time period during which the slidable region slides to the response region. The determination module is configured to determine whether the sliding duration is shorter than a preset duration. In these embodiments, the target function determination module 303 is further configured to perform the determination of the target function according to the position of the end point if the sliding duration is shorter than the preset duration. The processing module is configured to stop responding to the sliding operation if the sliding duration is greater than or equals the preset duration.

In some embodiments, the target function determination module 303 is further configured to determine the target function to be a screenshot function if the position of the end point is in a first response segment or determine the target function to be a lock screen function if the position of the end point is in a second response segment.

In some embodiments, a center of the slidable region coincides with a center of the response region.

In some embodiments, the slidable region has a circular shape and the response region has an annular shape surrounding the slidable region.

In some embodiments, there is a preset distance between the slidable region and the response region.

Operations of individual modules in a device consistent with the present disclosure are similar to the exemplary methods described above, and thus are not described in detail here.

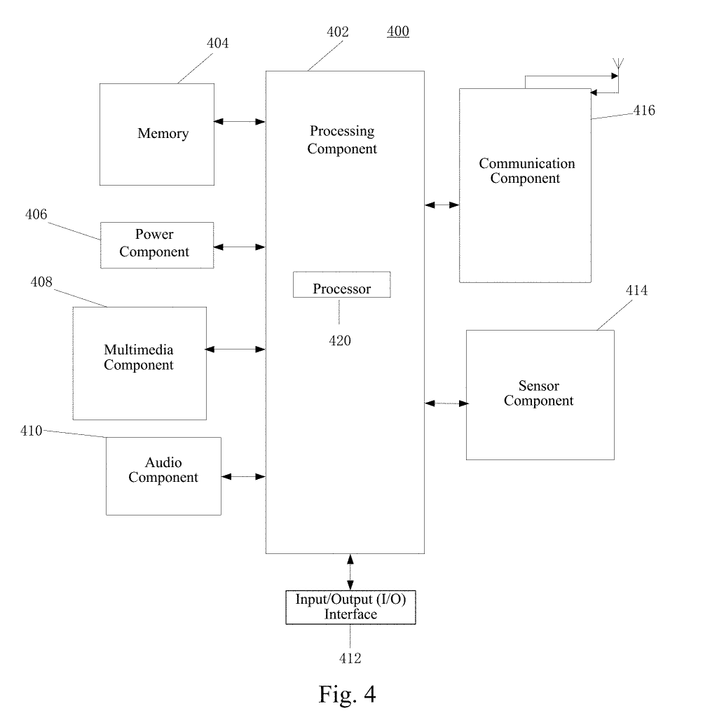

FIG. 4 is a block diagram of a device 400 for processing an operation according to another exemplary embodiment. For example, the device 400 may be a mobile phone, a computer, a digital broadcast terminal, a messaging device, a gaming console, a tablet, a medical device, exercise equipment, a personal digital assistant, or the like.

Referring to FIG. 4, the device 400 may include one or more of the following components: a processing component 402, a memory 404, a power component 406, a multimedia component 408, an audio component 410, an input/output (I/O) interface 412, a sensor component 414, and a communication component 416.

The processing component 402 typically controls overall operations of the device 400, such as the operations associated with display, telephone calls, data communications, camera operations, and recording operations. The processing component 402 may include one or more processors 420 to execute instructions to perform all or part of a method consistent with the present disclosure, such as one of the above-described exemplary embodiments. Moreover, the processing component 402 may include one or more modules which facilitate the interaction between the processing component 402 and other components. For instance, the processing component 402 may include a multimedia module to facilitate the interaction between the multimedia component 408 and the processing component 402.

The memory 404 is configured to store various types of data to support the operation of the device 400. Examples of such data include instructions for any applications or methods operated on the device 400, contact data, phonebook data, messages, pictures, video, etc. The memory 404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or optical disk.

The power component 406 provides power to various components of the device 400. The power component 406 may include a power management system, one or more power sources, and any other components associated with the generation, management, and distribution of power in the device 400.

The multimedia component 408 includes a screen providing an output interface between the device 400 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 408 includes a front camera and/or a rear camera. The front camera and the rear camera may receive external multimedia data while the device 400 is in an operation mode, such as a photographing mode or a video mode. Each of the front camera and the rear camera may be a fixed optical lens system or have focus and/or optical zoom capability.

The audio component 410 is configured to output and/or input audio signals. For example, the audio component 410 includes a microphone configured to receive an external audio signal when the device 400 is in an operation mode, such as a call mode, a recording mode, and a voice recognition mode. The received audio signal may be further stored in the memory 404 or transmitted via the communication component 416. In some embodiments, the audio component 410 further includes a speaker to output audio signals.

The I/O interface 412 provides an interface between the processing component 402 and peripheral interface modules, such as a keyboard, a click wheel, buttons, and the like. The buttons may include, but are not limited to, a home button, a volume button, a starting button, and a locking button.

The sensor component 414 includes one or more sensors to provide status assessments of various aspects of the device 400. For instance, the sensor component 414 may detect an open/closed status of the device 400, relative positioning of components, e.g., the display and the keypad, of the device 400, a change in position of the device 400 or a component of the device 400, a presence or absence of user contact with the device 400, an orientation or an acceleration/deceleration of the device 400, and a change in temperature of the device 400. The sensor component 414 may include a proximity sensor configured to detect the presence of nearby objects without any physical contact. The sensor component 414 may also include a light sensor, such as a CMOS or CCD image sensor, for use in imaging applications. In some embodiments, the sensor component 414 may also include an accelerometer sensor, a gyroscope sensor, a magnetic sensor, a pressure sensor, or a temperature sensor.

The communication component 416 is configured to facilitate communication, wired or wirelessly, between the device 400 and other devices. The device 400 can access a wireless network based on a communication standard, such as WiFi, 2G, 3G, or 4G, or a combination thereof. In one exemplary embodiment, the communication component 416 receives a broadcast signal or broadcast associated information from an external broadcast management system via a broadcast channel. In one exemplary embodiment, the communication component 416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth technology, or another technology.

In exemplary embodiments, the device 400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing a method consistent with the present disclosure, such as one of the above-described exemplary methods.

In exemplary embodiments, there is also provided a non-transitory computer-readable storage medium including instructions, such as the memory 404 including instructions executable by the processor 420 in the device 400, for performing the above-described methods. For example, the non-transitory computer-readable storage medium may be a ROM, a RAM, a CD-ROM, a magnetic tape, a floppy disc, an optical data storage device, and the like.

According to the present disclosure, there is also provided a non-transitory computer-readable storage medium having stored therein instructions that, when executed by a processor of a mobile terminal, cause the mobile terminal to perform a method for processing an operation consistent with the present disclosure, such as one of the above-described exemplary methods.

Other embodiments of the disclosure will be apparent to those skilled in the art from consideration of the specification and practice of the disclosure. This application is intended to cover any variations, uses, or adaptations of the disclosure following the general principles thereof and including such departures from the present disclosure as within known or customary practice in the art. It is intended that the specification and examples be considered as exemplary only, with a true scope and spirit of the invention being indicated by the following claims.

According to the present disclosure, a user can control a terminal to perform a certain function by sliding a slidable region of a graphical representation displayed on an interface of the terminal to an end point in a response region of the graphical representation. Thus, the operation to trigger the function can be simplified and accelerated. As a result, the operation efficiency can be improved. A method consistent with the present disclosure provides more convenience particularly when the user uses one hand to hold the terminal.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for processing an operation, comprising:
displaying a graphical representation on a terminal interface, the graphical representation including a slidable region and a response region, the response region including a plurality of response segments, each response segment corresponding to one function;
acquiring, when a sliding operation on the slidable region is detected, a position of an end point of the sliding operation in the response region;
determining a target function according to the position of the end point, the target function corresponding to a response segment in which the position of the end point is located; and
enabling the target function.

2. The method of claim 1, wherein determining the target function includes:
determining, if the position of the end point is in a first response segment, the target function to be a screenshot function; or
determining, if the position of the end point is in a second response segment, the target function to be a lock screen function.

3. The method of claim 1, wherein displaying the graphical representation includes displaying the graphical representation such that a center of the slidable region coincides with a center of the response region.

4. The method of claim 1, wherein displaying the graphical representation includes displaying the graphical representation such that the slidable region has a circular shape and the response region has an annular shape surrounding the slidable region.

5. The method of claim 1, wherein displaying the graphical representation includes displaying the graphical representation such that there is a preset distance between the slidable region and the response region.

6. A method for processing an operation, comprising:
displaying a graphical representation on a terminal interface, the graphical representation including a slidable region and a response region, the response region including a plurality of response segments, each response segment corresponding to one function;
acquiring, when a sliding operation on the slidable region is detected, a position of an end point of the sliding operation in the response region;
acquiring a sliding duration during which the slidable region slides to the response region;
determining whether the sliding duration is shorter than a preset duration; and
if the sliding duration is shorter than the preset duration:
determining a target function according to the position of the end point, the target function corresponding to a response segment in which the position of the end point is located; and
enabling the target function.

7. A device for processing an operation, comprising:
a processor; and
a memory storing instructions that, when executed by the processor, cause the processor to:
display a graphical representation on a terminal interface, the graphical representation including a slidable region and a response region, the response region including a plurality of response segments, each response segment corresponding to one function;
acquire, when a sliding operation on the slidable region is detected, a position of an end point of the sliding operation in the response region;
determine a target function according to the position of the end point, the target function corresponding to a response segment in which the position of the end point is located; and
enable the target function.

8. The device of claim 7, wherein the instructions further cause the processor to:
determine, if the position of the end point is in a first response segment, the target function to be a screenshot function; or
determine, if the position of the end point is in a second response segment, the target function to be a lock screen function.

9. The device of claim 7, wherein the instructions further cause the processor to:
display the graphical representation such that a center of the slidable region coincides with a center of the response region.

10. The device of claim 7, wherein the instructions further cause the processor to:
display the graphical representation such that the slidable region has a circular shape and the response region has an annular shape surrounding the slidable region.

11. The device of claim 7, wherein the instructions further cause the processor to:
display the graphical representation such that there is a preset distance between the slidable region and the response region.

12. A device for processing an operation, comprising:
a processor; and
a memory storing instructions that, when executed by the processor, cause the processor to:
display a graphical representation on a terminal interface, the graphical representation including a slidable region and a response region, the response region including a plurality of response segments, each response segment corresponding to one function;
acquire, when a sliding operation on the slidable region is detected, a position of an end point of the sliding operation in the response region;
acquire a sliding duration during which the slidable region slides to the response region;
determine whether the sliding duration is shorter than a preset duration; and
if the sliding duration is shorter than the preset duration:
determine a target function according to the position of the end point, the target function corresponding to a response segment in which the position of the end point is located; and
enable the target function.

13. A non-transitory computer-readable storage medium storing instructions that, when executed by a processor in a terminal, cause the terminal to:
display a graphical representation on a terminal interface, the graphical representation including a slidable region and a response region, the response region including a plurality of response segments, each response segment corresponding to one function;
acquire, when a sliding operation on the slidable region is detected, a position of an end point of the sliding operation in the response region;
determine a target function according to the position of the end point, the target function corresponding to a response segment in which the position of the end point is located; and
enable the target function.
